(19) United States
(12) Patent Application Publication
(10) Pub. No.: US 2003/0190955 A1
(43) Pub. Date: Oct. 9, 2003

(54) Device for activating at least one person

(75) Inventor: Frank Weiss, Halle (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Thomas RYLL, Magdeburg (DE)

(21) Appl. No.: 10/406,900

(22) Filed: Apr. 3, 2003

Related U.S. Application Data
(60) Provisional application No. 60/370,914, filed on Apr. 8, 2002.

(51) Int. Cl. G06F 17/00

(52) U.S. Cl. 463/36; 463/37

(57) ABSTRACT

The invention relates to the device for activating at least one person with at least one module (12) that can be perceptually controlled by the at least one person. According to the invention, the module (12) includes at least one means which can be used by the at least one person (48) to deactivate at least a part of the perceptual control of the at least one module (12) and/or deactivate the perceptual control of the at least one module (12) at least for a period of time.

This application is a non-provisional application based on serial No. 60/370,914, filed on Apr. 8, 2002.

The invention relates to a device for activating at least one person.

In the context of this invention, activating at least one person is to be understood as a specific movement training, an specific therapeutic exercise, a specific movement animation or the like of a person. The specific activation can be employed for sports, medical or therapeutic reasons.

Training and/or therapeutic equipment and devices of different types are known in the art. Such equipment is generally known as sports and/or fitness equipment offer a person the possibility for a specific therapeutic exercise and/or a specific training. The known equipment can be static or dynamic. Different movements are possible depending on the equipment's design. It is also known to combine such devices with so-called minicomputers, so that different training patterns and/or movement patterns can be simulated. Ergometers should be mentioned at this point as a specific example.

These known devices have the disadvantage that they have limited flexibility in their use, and may be suitable only for specific movements.

It is therefore an object of the invention to provide a device of the aforedescribed type which has a simpler construction and can be flexibly adapted to different movements.

According to the invention, the object is solved by a device having the characterizing features recited in claim 1. By providing the module with at least one means which can be used by the at least one person to deactivate at least a part of the perceptual control of the at least one module and/or deactivate the perceptual control of the at least one module at least for a period of time, a reaction of the at least one person for deactivating the perceptual control is advantageously elicited from the person through the perceptual control of the at least one module. The deactivation is connected with a quasi-forced or compulsory movement of the person, depending on the position of the perceptually controllable module relative to the at least one person. Accordingly, specific movements and responses of persons can be initiated, resulting in a very efficient therapeutic exercise and/or motion training.

According to another embodiment of the invention, the module includes at least one controllable segment. In particular, the module advantageously includes a plurality of segments arranged in a predetermined grid pattern, in particular at intersecting vertical and/or horizontal and/or diagonal lines. Such configuration offers superior flexibility to visualize different movement patterns. In particular, individually configured therapeutic exercises or motion training for a specific person or a specific sport can be easily implemented, taking into account ergonomic considerations.

According to a preferred embodiment of the invention, the at least one module can form a surface element, which is preferably configured curved or straight. In particular, the surface element can be concave or convex. This allows an optimal position of the individual segments of the modules relative to the at least one person, so that the therapeutic and/or training measures can not only be optimally adapted of the available space, but can in addition also be adapted to particular situations.

According to another preferred embodiment, the at least one module can be arranged in front of and/or behind and/or to the left and/or to the right and/or above and/or underneath the at least one person. A plurality of modules, each of which can have a plurality of individual segments, can be combined into a device which allows specific therapeutic exercises and/or a specific motion training in several directions in space.

According to the actual application of the device, for example as a training device in competitive sport, a training device in fitness centers, sports academies or therapy centers, such as rehabilitation centers and the like, a device suitable for the specific requirements can be assembled in modular form. More particularly, the device can be expanded, starting with a module that is located essentially opposite to the person to be activated, by at least one additional module that is oriented at an angle to the first module.

Feasible is here a diagonal arrangement, in particular in a rectangular configuration as well as an arrangement with acute or obtuse angles. In the ticket, a concave and/or convex configured module allows a compact form several possibilities for applications in the aforedescribed areas.

According to yet another advantageous embodiment of the invention, the segments emit optical and/or acoustic signals in response to the perceptual control. When the at least one person perceives the optical and/or acoustic signals, the person can deactivate exactly those segments that emit the optical and/or acoustic signals. The movement of the person is stimulated according to a presettable frequency and/or time duration of the emission of the optical and/or acoustic signals. It will be understood that different therapeutic exercises and/or motion training patterns can be defined by presetting the frequency and/or time duration of the optical and/or acoustic signals. The frequency and/or the time duration of the optical and/or acoustic signals of individual segments can also be varied during the duration of a training unit and/or therapeutic unit.

According to still another advantageous embodiment, the segments can change their shape in response to the perceptual control, in particular through pneumatic and/or hydraulic control. This enables additional embodiments which allow the at least one person to either optically perceive or sense of the activation of a segment. The various combinations of optical and/or acoustic and/or pneumatic or hydraulic control also enable other therapeutic and training possibilities, for example, for vision- and/or hearing-impaired persons.

According to another advantageous embodiment to the invention, the segments can include at least one illuminating means and, according to another preferred embodiment, a plurality of illuminating means that radiate electromagnetic waves in different wavelength ranges. Optical signals can be provided in different colors depending on the selection of the at least one illuminating means. Signaling in different colors can elicit different perceptual reaction from the persons to be activated, so that different reaction speeds of the persons can be obtained and/or trained and/or therapeutically implemented based on otherwise identical movement patterns by controlling the same segments with different color schemes.

The at least one illuminating means is preferably implemented as a light emitting diode or the like, so that the illumination means can be easily integrated in the segments without requiring a large installation space, while also reducing the energy consumption of the illumination means.

According to yet another advantageous embodiment of the invention, the segments can include interchangeable cover elements which more particularly can have a different shape and/or a different material strength and/or can be made of a different material. This advantageously also allows adaptation to the different training and/or therapeutic measures. For example, the material strengths and/or material selection and/or form can produce different activation forces of the segments necessary to deactivate the individual segments. In this way, the force exerted during the movement can be trained or included in the therapy in addition to the reaction speed. Also, different training methods can be easily incorporated for different types of sports or the like. Preferably, the cover elements can be made of plastic, in particular of an optically transparent plastic. In this way, the shape and/or material strength of the cover lids can be configured in addition to optical signaling. In particular, the weight of the cover elements and hence also of the segments and the modules is minimized, so that the device can be configured for mobility and flexibility.

According to still another advantageous embodiment of the invention, the switching means for deactivating the individual segments can be operated contactless or mechanically. Depending on the selected embodiment, a segment can be deactivated, for example, by applying an actuation force—which, as described above, can be set to be variable—or contact-less, for example with an infrared sensor or the like, when a part of a person's body approaches the segment to be deactivated.

According to yet another advantageous embodiment of the invention, the device includes a controller for controlling the at least one module and/or for acquiring and/or recording the deactivation of the at least one segment and/or the at least one module. In particular, in another preferred embodiment of the invention, the controller can be freely programmed, so that different training programs and/or therapeutic programs can be implemented with the device of the invention. For example, the frequency and/or the time duration of the signals emitted by the individual segments can be programmed. In particular, different degrees of difficulty, different movement patterns to be trained and different training times can be programmed. For example, the controller can be programmed by taking into consideration the ergonomics of the person.

Advantageously, the controller can include means for person-specific programming. In this way, the device can be programmed for individuals depending on the desired degree of difficulty and/or the desired movement patterns. The device of the invention can then be flexibly used for many purposes.

Advantageously, the controller can include storage means for person-specific storage of the activation and/or deactivation processes, wherein the controller preferably includes at least one input/output unit for reading and/or writing person-specific activation and/or deactivation processes. In this way, the programming code for the individual person can advantageously be intermediately stored, so that the controller and hence also the device need not be reprogrammed each time from the beginning. The deactivation processes can at the same time be acquired and stored to make them available for later comprehensive evaluation. In particular, reaction times between the activation of the segments and deactivation of the segments can be measured so as to arrive at conclusions about the motion performance of the person to be activated. The training programs and/or therapeutic programs can then be easily optimized. In particular, deactivation times of the individual segments can be compared with each other, so that the motion performance of the person to be activated can be matched exactly and optionally calculatingly trained.

In addition, according to an advantageous embodiment of the invention, the input/output unit can be a chip card reader. In this way, the person-specific programming and/or the person-specific control and/or deactivation processes can be stored on the chip card, so that the device can be easy be programmed by inserting the chip card into and/or pulling the chip card out of the controller. The acquired deactivation processes can also be transferred in this way. Accordingly, the individual results can subsequently be easily acquired, archived and/or processed—independent of the actual device of the invention.

Finally, according to a preferred embodiment of the invention, the controller can be connected to the at least one module via an interface which can be wireless or wired. This interface is preferably bidirectional, so that the control signals and/or the deactivation signals can be easy exchanged between the at least one module and the controller. The interface can be, for example, an infrared interface, so that no additional wires have to be connected. However, other embodiments using, for example, wireless transmission, optical waveguides, electrical wiring and the like are also feasible.

Additional preferred embodiments of the invention are recited in the dependent claims.

The embodiments of the invention will be described hereinafter with reference to the appended drawings. It is shown in:

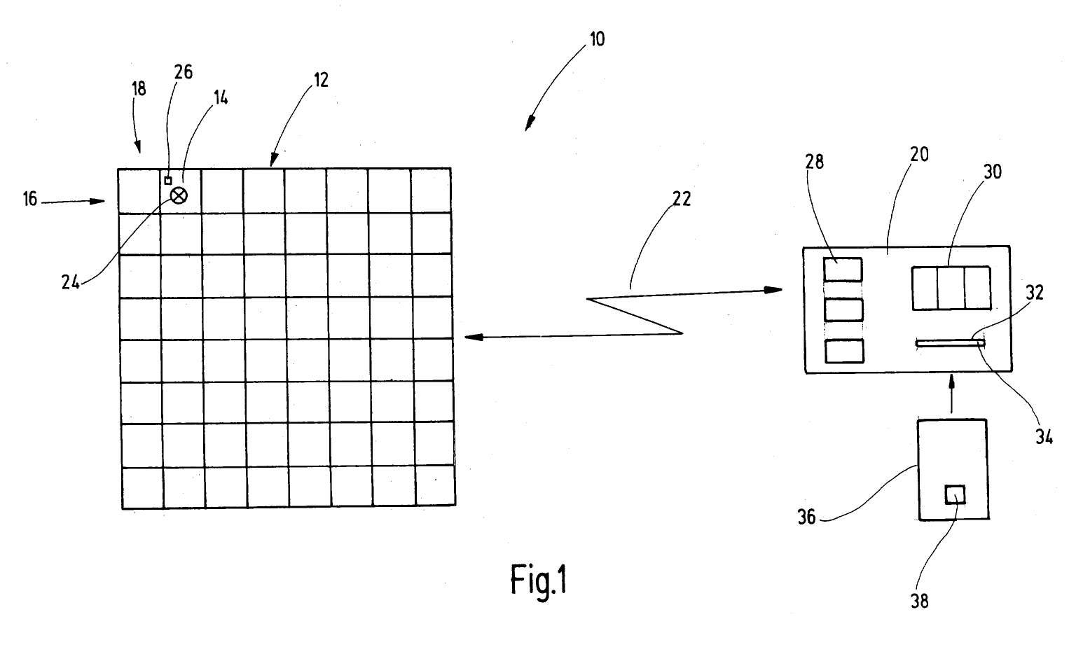

FIG. 1 a schematic view of the device of the invention;

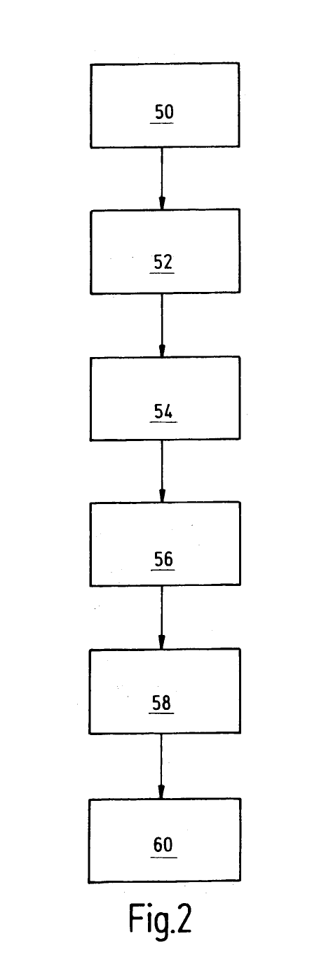

FIG. 2 a block diagram depicting the function of the device of the invention;

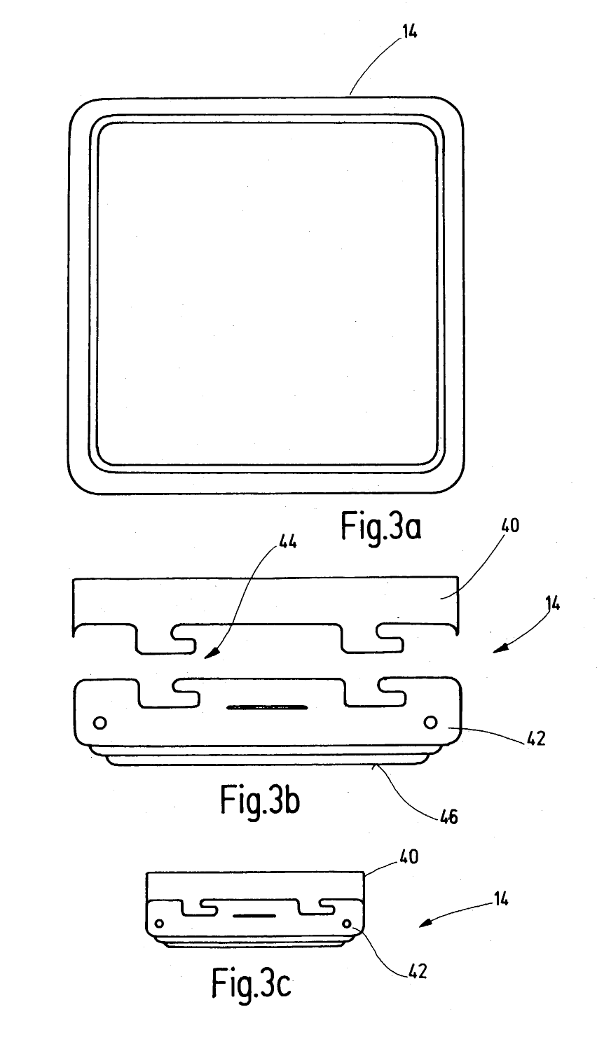

FIGS. 3a to 3c different views of a segment of the device of the invention; and

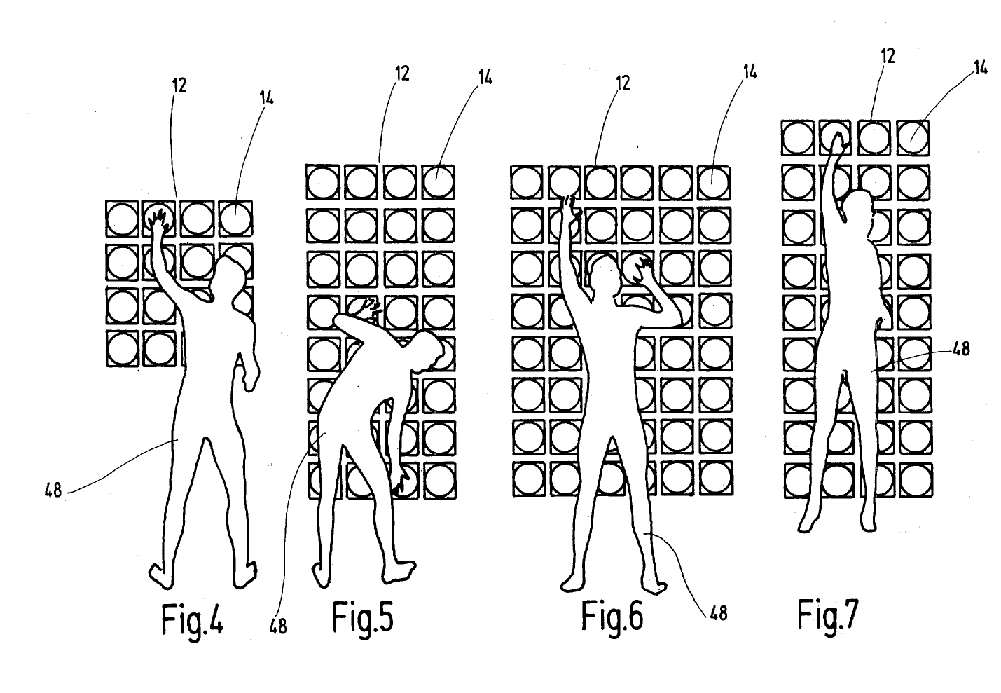

FIGS. 4 to 7 schematically, different embodiments of the invention.

FIG. 1 shows a device, indicated with reference numeral 10, for activating at least one person (not shown in FIG. 1). The device can include at least one module 12 comprised of a plurality of segments 14. As can be seen from the illustration in FIG. 1, the segments are arranged in a grid pattern comprised of rows 16 and columns 18. The number of rows 16 and columns 18 is variable. The number of segments 14 can be freely selected depending on the desired configuration or desired training and/or therapy patterns, as described below.

As seen in FIG. 1, the module 12 can be formed as a unit with a flat surface. According to other embodiments (not shown), the module 12 can also have a curved concave and/or convex shape—in the direction of the columns 16 and/or in the direction of the rows 18. The shape of the segments 14 can be selectively combined into the aforedescribed concave or convex shapes. The segments 14 can also be flexible, so that their shape can be a changeably adapted to the desired applications.

A controller 20 which communicates with the module 12 via a bidirectional interface 22 is associated with the module 12. Each of the segments 14 includes at least one illumination means 24, in particular at least one light emitting diode that can be controlled by the controller 20, i.e., supplied with a supply voltage. In addition, each segment 14 includes a schematically indicated switching means 26 for deactivating the illumination means 24 that is driven by the controller 20.

In the diagram of FIG. 1, only one illumination means 24 and one switching means 26 associated with one segment 14 is shown. However, it will be understood that each of the segments 14 can have such illumination means 24 and switching means 26.

The individual illumination means 24 of the segments 14 can be variably controlled by the controller 20. Each illumination means 24 can be individually controlled by associating each segment 14 with row and/or a column information. The controller 20 can also define a control frequency and/or a time duration for each of the illumination means 24.

The controller 20 includes control devices 28 (indicated only schematically) which can be used to program the controller 20. Integrated in the controller 20 are means 30 which include, in particular, storage means, computing means and the like and which can be used to process signals. In addition, the controller includes an input and output unit 32 which is advantageously implemented as a chip card reader 34. A chip card 36 with at least one memory means 38 can be inserted into the chip card reader 34.

The device 10 depicted in FIG. 1 has the following functionality illustrated in the flow diagram of FIG. 2:

A person using the device 10 has in his/her possession the person-specific chip card 36 which is inserted into the controller 20 in a first step 50. In a next step 52, the controller 20 receives from the memory means 38 of the chip card 36 the person-specific programming information and stores the programming information in the means 30. In the following step 54, the means 30 determine from the person-specific programming information the control signals for the illuminating means 24 of the individual segments 14. This relates in particular to the order, the selection, the frequency and/or the duration with which the different segments 14 are driven. Depending of the person-specific programming, not all segments 14 need to be energized, but rather only a subset of the segments 14 associated with the desired training and/or therapeutic program. The person-specific programming information can also contain the total duration of the training program and/or therapeutic program. The control program is started by activating “Start” (step 56) of the device 10, for example, by activating one of the pushbuttons 28 or the like. The person then takes up position within reach of the module 12 and deactivates with his/her limbs, for example his/her hand and/or feet, the previously activated segment 14. Based on the optical signal transmitted by the illuminating means 24, the person recognizes which segment 14 is activated and therefore has to be deactivated. According to additional embodiments, the optical signal can be combined with an acoustic signal. Deactivation of the segment 14 by the person is transmitted to the controller 20 via the interface 22 (step 58), with the controller intermediately storing the information in the means 30. In particular, the delay between the activation of a segment 14 and its deactivation can be measured. According to this method, the person-specific program is processed during the selected time period.

After the training and/or therapeutic program is concluded, the intermediately stored deactivation information of the person can be read onto the memory chip 38 of the person-specific chip card 36 (step 60), so that this information is available for a subsequent detailed evaluation or archiving or the like.

The use of a chip card 36 is only exemplary, and other suitable memory means and/or acquisition means can, of course, also be used.

According to another embodiment of the invention (not shown), the person to be activated can be provided with or connected to at least one measurement means, which measures at least one body signal, such as the pulse rate, blood pressure, temperature, brain waves and the like. The at least one measurement means can be connected with the controller 20 so as to affect the control of the device 10 depending on the immediate condition of the person.

FIG. 3 shows different views of a segment 14. FIG. 3a shows a top view of the segment 14, whereas FIG. 3b shows a cross-sectional view. As seen in the cross-sectional view of FIG. 3b, the segment 14 consists of a base element 40 and a cover element 42. The base element 40 can be attached to a support, for example a movable wall or a fixed wall of a room. The cover element 42 can be connected to the base element 40 through snap connections 44 or the like. The cover element 42 is made of an optically transparent plastic, so that the illuminating means 24 arranged in the interior (not shown in FIG. 3) of the segment 14 can radiate the electromagnetic waves through the cover element 42. The cover element 42 also forms an actuation surface 46, allowing the person to deactivate the illuminating means 24 by operating the switching element 26. With this arrangement, the cover element 42 can have a shape and/or or material strength or material properties adapted to the specific actuation force required for deactivating the illuminating means 24. For example, a different actuation force for deactivating the corresponding illuminating means 24 can be set for different training programs or therapeutic programs. In this way, a specific training program for certain movements and/or certain muscles of the person can be implemented.

FIG. 3c finally shows at a reduced scale a segment 14 wherein the cover element 42 interlocks with a base element 40. Not shown for sake of clarity are the illuminating means 24 as well as the switching means 26 and the signal and/or voltage lines to the segments 14.

FIGS. 4 to 7 show schematically different shapes and sizes of modules 12. A person 48 which deactivates the individual segments 14 through corresponding movements is associated with each of the modules 12, as described above. The size, height, and arrangement of the modules 12 can be adapted to the desired training program and/or therapeutic program.

It is clear from the features described above that by using the device 10, persons 48 can optimally train their condition, reaction time, speed and fitness with the help of optical signals using touch and action. In particular, specific movement patterns and reactions can be trained. Through simple modifications, the device 10 can be adapted to the different training methods and/or training programs and different therapeutic methods and/or therapeutic programs. The device 10 can be used for competitive sport as well as for popular sport and general physical exercise and for therapeutic purposes in medicine. Modules 12 can be flexibly assembled from segments 14. The corresponding specific requirements of the persons 48 can be met by the particular arrangement of the individual segments 14 or modules 12, for example based on ergonomics. This makes possible configurations for training in different forms of sports. In particular, the device 10 can be adapted to a specific body height, a reaction radius and to tactile characteristics of the persons 48 to be activated. The device can also be easily adapted to the available space.

Acquiring the deactivation processes makes it possible to determine the sensory and switching reactions of the persons 48 and hence to evaluate their reaction, therapeutic parameters and progress with treatment and training.

List of Reference Numerals

10 device

12 module

14 segment

16 row

18 column

20 controller

22 interface

24 illumination means

26 switching means

28 actuation devices

30 means

32 input/output unit

34 chip card reader

36 chip card

38 memory means

40 base element

42 cover element

44 snap connection

46 actuation surface

48 person

50 step

52 step

54 step

56 step

57 step

60 step

1. Device for activating at least one person (48) with at least one module (12) that can be perceptually controlled by the at least one person (48), wherein the module (12) includes at least one means which can be used by the at least one person (48) to deactivate at least a part of the perceptual control of the at least one module (12) and/or deactivate the perceptual control of the at least one module (12) at least for a period of time.

2. Device according to claim 1, wherein the module (12) includes at least one controllable segment (14).

3. Device according to claim 1, wherein the module (12) includes a plurality of segments (14) arranged in a predetermined grid pattern.

4. Device according to claim 1, wherein the segments (14) are arranged at intersecting vertical and/or horizontal and/or diagonal lines.

5. Device according to claim 1, wherein the at least one module (12) forms a surface element.

6. Device according to claim 1, wherein the surface element is straight.

7. Device according to claim 1, wherein the surface element is curved.

8. Device according to claim 1, wherein the surface element is concave.

9. Device according to claim 1, wherein the surface element is convex.

10. Device according to claim 1, wherein the device (10) includes at least two modules (12).

11. Device according to claim 1, wherein the at least two modules (12) can be arranged at a selectable angle relative to each other.

12. Device according to claim 1, wherein the at least two modules (12) can be arranged at right angles with respect to each other.

13. Device according to claim 1, wherein the at least two modules (12) are arranged opposite of each other.

14. Device according to claim 1, wherein the at least one module (12) is arranged in front of an/or behind and/or to the left and/or to the right and/or above and/or underneath the at least one person (48).

15. Device according to claim 1, wherein in response to the perceptual control, the segments (14) emit optical and/or acoustic signals.

16. Device according to claim 1, wherein in response to the perceptual control, the segments change their shape.

17. Device according to claim 16, wherein the control is pneumatically and/or hydraulically.

18. Device according to claim 1, wherein the segments include at least one illuminating means (24).

19. Device according to claim 1, wherein the segments (14) includes a plurality of illuminating means (24) that radiate electromagnetic waves in different wavelength ranges.

20. Device according to claim 1, wherein the illuminating means (24) are light-emitting diodes or the like.

21. Device according to claim 1, wherein the segments (14) comprise interchangeable cover elements (42).

22. Device according to claim 1, wherein the cover elements (42) have a different shape and/or a different material strength and/or are made of a different material.

23. Device according to claim 1, wherein the cover elements (42) are made of plastic, in particular an optically transparent plastic.

24. Device according to claim 1, wherein the at least one means for deactivating the at least one segment (14) is a switching means (23).

25. Device according to claim 1, wherein the switching means (26) is a switch contact.

26. Device according to claim 1, wherein the switch contact can be operated contactless or mechanically.

27. Device according to claim 1, wherein the device (10) comprises a controller (20) for controlling the at least one module (12) and/or for acquiring and/or recording the deactivation of the at least one segment (14) and/or the at least one module (12).

20. Device according to claim 1, wherein the controller (20) can be freely programmed.

29. Device according to claim 1, wherein the controller (20) includes means for person-specific programming.

30. Device according to claim 1, wherein the controller (20) includes storage means for person-specific storage of the activation and/or deactivation processes.

31. Device according to claim 1, wherein the controller (20) includes at least one input/output unit for reading and/or writing person-specific actuation and/or deactivation processes.

32. Device according to claim 1, wherein the input/output unit (32) is a chip card reader (34)

33. Device according to claim 1, wherein the controller (20) is connected to the at least one module (12) via an interface (22).

34. Device according to claim 1, wherein the interface (22) is implemented wireless or wired.

35. Device according to claim 1, wherein the interface (22) is an infrared interface.

36. Device according to claim 1, wherein the interface (22) operates bidirectionally.
